(19) United States
(12) Patent Application Publication
(10) Pub. No.: US 2015/0350733 A1
(43) Pub. Date: Dec. 3, 2015

(54) SYSTEMS AND METHODS FOR OPINION SHARING RELATED TO LIVE EVENTS

(71) Applicant: Grid News Bureau, LLC, Arvada, CO (US)

(72) Inventor: Aris Persidis, Arvada, CO (US)

(73) Assignee: Grid News Bureau, LLC

(21) Appl. No.: 14/727,980

(22) Filed: Jun. 2, 2015

Related U.S. Application Data
(60) Provisional application No. 62/006,876, filed on Jun. 2, 2014.

(51) Int. Cl. H04N 21/475; H04N 21/2187; H04N 21/4788

(52) U.S. Cl. CPC H04N 21/4758; H04N 21/4788; H04N 21/2187

(57) ABSTRACT

A system for sharing opinions related to live events including an opinion sharing mechanism including an action selection section including user controls through which a first user makes a user selection to share a first user opinion related to the associated live event, wherein the first user opinion shared is a selection of an identifiable action that may transpire within the live event. The first user opinion is compared against additional user selections and, in response to the comparison of the first user selection against the additional user selections, displaying a scoring display communicating: the identifiable action most commonly selected; the percentage of users selecting the most commonly selected identifiable action; the identifiable action selected by the first user; and the percentage of users selecting the identifiable action selected by the first user.

### BACKGROUND OF THE INVENTION

The present subject matter relates generally to systems and methods that enable users to participate in opinion sharing activities during live public events (sports and others). In one embodiment, the systems and methods are implemented in a mobile or web application through which, among other things: users share their opinions as to what may be the best play calls in one or more live sporting events; the application compares users' answers against the answers of other users and the events in the sporting event, tracks user's predictive agreement rate (absolutely and relatively), provides a user leaderboard, and generates and displays a geographic map of active users.

Professional sports fans are one of the most popular target demographics for advertisers and broadcast networks. Attracting and retaining the empowered fan is a constant battle. The competition among networks for audience appeal and engagement drives the search for innovation, differentiation, and new revenue opportunities. New types of proprietary content are highly prized and can be an exceptionally important component of the differentiation, appeal, and revenue strategy for advertisers and broadcast networks.

A number of activities have been developed to get spectators to be more involved in and engaged in their sports viewing. Examples of these activities include fantasy sports leagues, legal (and illegal) gambling, including betting on outcomes, and other similar systems.

These activities fall short when it comes to most directly accommodating the so-called “armchair coach”—the dedicated fan who calls out plays from their seats. Whether these individuals believe that their knowledge of the team or league enables them to make the best offense and defense play calls, or they simply enjoy the engagement in the sport, it is an untapped opportunity for fan engagement. Currently, these fans have no way of sharing, tracking and measuring their play calling opinions during live events, particularly with respect to other fans. They do not have a way to compare their calls against those of other “armchair coaches” and track the agreement of their calls relative to the opinion of a crowd of fans.

While the above example relates specifically to sporting events, easy analogies can be drawn to political events, e.g., elections, live contests, e.g., reality television competitions, etc. In those examples, the opinion of what play to run is substituted with an opinion of some measurable activity in the event. But the overall concept is the same in that the political junkies and the fans of reality television can also be an actively engaged audience that would like to interact with live events in a more meaningful manner.

Accordingly, there is a need for a system and method for opinion sharing related to live events, comparing those opinions against other spectators, and tracking the user's agreement rate with other users, as described herein.

### BRIEF SUMMARY OF THE INVENTION

To meet the needs described above and others, the present disclosure provides systems and methods for live event opinion sharing, such as, for example, the sharing of opinions related to play calls in a live sporting event. The systems and methods provide a platform through which users share their opinions as to which plays to call (or analogous opinion) in one or more live events; the application compares users' answers against the answers of other users and, separately, against the events that transpire in the live event, tracks user's agreement rate (absolutely and relatively), provides a user leaderboard, and generates and displays a geographic map of active users.

In one embodiment, the systems and methods are embodied in a software application, such as a mobile application or a web application. In such embodiments, the system includes a central controller (e.g., a cloud-based server) and a plurality of distributed devices (e.g., mobile devices), wherein a corresponding plurality of users interact with user interfaces provided through the distributed devices to augment the experience of a live event. In one example of such a system, a first data stream, or first set of data steams, is provided from the live event to the central server; such data streams including situational data concerning the live event. For example, for a football game, the information may include information about the score, game clock, possession, play calls, play results, etc. This information is what is used by the program applications running on the central server to push the data to the user interfaces running in the distributed devices. Accordingly, a second data stream, or second set of data streams, is provided from the central server to each of the distributed devices; such data stream updating the application running on the distributed devices. Finally, a third data stream, or third set of data steams, is provided from the distributed devices back to the central server; relaying the information received through the user interfaces back to the central server.

A primary example used to describe the functionality of the solutions provided in this disclosure relates to fan interaction with a live NFL game. In such an embodiment, a user may watch an NFL game, share an opinion as to what the user thinks the offense or defense should do, see how the other users voted, receive a score based on agreement with the other users, and win prizes. Through the system, the content collected and generated by the central server includes live fan opinion sharing data, trends, live leaderboards, and fan geographical distribution. These systems and methods are not only engaging for the fan in real-time, but can capture very interesting and valuable data that becomes more interesting after the fact when the context of the situation is better understood.

For example, during Super Bowl XLIX on Feb. 1, 2015, as the game was nearing the final moments, Seattle Seahawks quarterback, Russell Wilson, threw a game deciding interception to New England Patriot's rookie defensive back, Malcolm Butler. At the time of the play, and in the days following the Super Bowl, many commentators remarked that this was one of the worst play calls in the history of Super Bowls, or even in the history of football. However, this hindsight analysis can be given additional context using the systems and methods provided herein. For example, a live implementation of the systems and methods described herein during Super Bowl XLIX, 15% of the participating fans called for Wilson to pass the ball on that crucial play, 20% called for a bootleg, and only 65% called for a power run. These may not be the percentages fans and commentators now expect in hindsight (i.e., knowing the outcome of the play), but prior to the snap, the play call did not seem so singularly obvious to the users. These percentages may represent the opinions of users as to what they think should happen as a strategy and not what they bet will happen as an outcome.

By providing a mechanism for user inputs regarding live sporting events, the present invention allows users to see their rate of agreement of their play calls with other users. This combination of real-time, live voting and crowd comparison gives users a unique way of engaging in live events.

The elements of the solution may include a software application operating through an electronic device that is configured to maintain personalized user accounts, a menu within this application of nationally and/or locally televised games from which to select, a menu within the application of plays from which to select, voting capability, vote tracking and aggregation capability, an engine awarding and tracking points, and a website where users may view their results against other users.

In a preferred embodiment, the system and method may operate through a software application that offers users the option of selecting a specific sporting event. The user may maintain a personal account within this application. To initiate the system, the user chooses the game he wishes to watch from a list of sporting events covered by the application.

While watching the sporting event, the user may make play calls within the application. To accomplish this, the application may provide various data points, including the segment of the game, the game time, the down (if football), score, the team on offense and team on defense, etc. so the user knows the game is in sync with application. The application may offer the user a comprehensive selection of specific offense, defense, and/or special teams plays. The application may further may incorporate educational descriptions to help facilitate the user's learning and to make the application accessible to novice spectators.

Once the user has entered the play selection, the application may compare the selected play against other users selecting plays at that time for the same game.

The system may employ a time limit for making a play call, such as within ten seconds of the entered game time. In response to a user's play selection, the app may reveal a comparison of the user's selection relative to the aggregate selection of users selecting on the same play. The system will use synchronization of game time, score, down, etc. to match user votes for each play.

The app may further maintain a database of the user's play calls in order to track information about the user's success rate. The app may also include a points system that awards users points based on the success of their play calls (for example, measured in terms of accuracy with the actual sporting event or agreement with the aggregate play calls).

The systems and methods may also include a scoreboard component where users may compare their points versus other users. This scoreboard may further recognize the achievements of points leaders.

The systems and methods may include a system administrator (including an automated software administrator) who loads the valid games, plays, and also various data points, including the segment of the game, the game time, the down (if football), score, the team on offense and team on defense into the application on the server side. The system administrator may also control the periods for selection.

The application may run in cycles that correspond to the season during which the sport takes place. For example, at the end of the season when there are no longer any games available, the application may erase the user's points and start over for the next season. Additionally, the system may allow the user to view scores across a variety of variables, such as defense calls, offense calls, post-season versus regular season, etc.

The systems and methods may operate to provide selection comparison for a variety of sporting events and non-sporting events. In addition to football, the application may work in connection with other sports. For example, the system may be used to call pitches in baseball, maneuvers in wrestling, maneuvers in car racing, etc. One potential non-sport application is selecting the plot direction of a television show. A further non-sporting use would be in elections for office, where a viewer of a debate can enter an opinion as to which topical direction the debate will go while watching a live debate.

The system and method may be further adapted to receive selections and inputs from professional players and coaches. A comparison can be made against other players, and also against the play agreement of a professional coach. In such an instance, a professional coach is watching the game and uploads an interpretation of the actual play that took place. Then, the professional's choice is used for comparison, in addition to, or as an alternative to, the crowd comparison.

In one embodiment, the system or sharing opinions related to live events, the system includes: a processor; and a memory including instructions that when executed by the processor cause it to: provide a first graphical user interface embodying an opinion sharing mechanism including: a live event information section including real-time information related to an associated live event; and an action selection section including user controls through which a first user makes a user selection to share a first user opinion related to the associated live event, wherein the first user opinion shared is a selection of an identifiable action that may transpire within the live event; receive the first user selection; compare the received user selection against a plurality of additional user selections received from a corresponding number of additional users that provide the additional user selections through additional opinion sharing mechanisms including: a live event information section including real-time information related to an associated live event; and an action selection section including user controls through which the additional users make their user selections to share the additional user opinions related to the associated live event, wherein the additional user opinions shared are a selection of identifiable actions that may transpire within the live event; in response to the comparison of the first user selection against the additional user selections, display, through the first graphical user interface, a scoring display communicating: the identifiable action most commonly selected; the percentage of users selecting the most commonly selected identifiable action; the identifiable action selected by the first user; and the percentage of users selecting the identifiable action selected by the first user. The scoring display may further communicate points assigned to the first user based on the degree of agreement between the first user selection and the additional user selections.

In some embodiments, the live event is an game. Accordingly, the selection of an identifiable action that may transpire within the live event may be the selection of an offensive play or a defensive play. The real-time information related to the associated live event may include situational data for the NFL game including team names, a score, a quarter, a team having possession of the ball, and a down. The action selection section may include a selection to access offensive plays or defensive plays.

The graphical user interface further may also include a playbook module including a play definition section and a play selection section, wherein user selection of a play displayed in the play selection section causes a description of the play to appear in the definition section.

In another example, the live event is an MLB game and the selection of an identifiable action that may transpire within the live event is the selection of a pitch. Alternatively, the live event is an automobile race and the selection of an identifiable action that may transpire within the live event is the selection of a driving move. In yet another example, the live event is a political debate and the selection of an identifiable action that may transpire within the live event is the selection of a political topic.

An object of the invention is to provide sports fans with the ability to compare their coaching selections in real-time during live plays with those of other spectators.

Another object of the invention is to provide a spectator activity that focuses on the design of a play, rather than the outcome.

An advantage of the invention is that it educates the user about competitive sports.

Another advantage of the invention is that it allows the user to see how their calls compare with other fans.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1A is a schematic diagram of the systems and methods presented herein.

FIG. 1B is a schematic diagram of a distributed device.

FIG. 2 is a representation of a screenshot of a user interface providing an NFL game related prediction entry mechanism.

FIG. 3 is a representation of a screenshot of a user interface providing personal scoring information in response to a play called through the prediction entry mechanism shown in FIG. 2.

FIG. 4 is a representation of a screenshot of a user interface providing a multiplayer aggregated scoreboard related to the prediction entry mechanism shown in FIG. 2.

FIG. 5 is a representation of a screenshot of a user interface providing an individual player aggregated scoreboard.

FIG. 6 is a representation of a screenshot of a user interface providing an NFL playbook associated with the prediction entry mechanism shown in FIG. 2.

FIG. 7 is a representation of a screenshot of a user interface providing an MLB game related prediction entry mechanism.

FIG. 8 is a representation of a screenshot of a user interface providing a race related prediction entry mechanism.

FIG. 9 is a representation of a screenshot of a user interface providing a political debate related prediction entry mechanism.

### DETAILED DESCRIPTION OF THE DRAWINGS

The disclosure provided herein teaches systems and methods through which users may share opinions related to live events, compare those opinions against other spectators, and track the user's agreement rate with other users. Although the primary examples provided herein are directed to sharing opinions related to live sporting events, based on the examples provided, those ordinary skilled in the art will recognize that there are numerous forms in which the unique solutions provided herein may be embodied, whether related to sporting events, political events, or other live events.

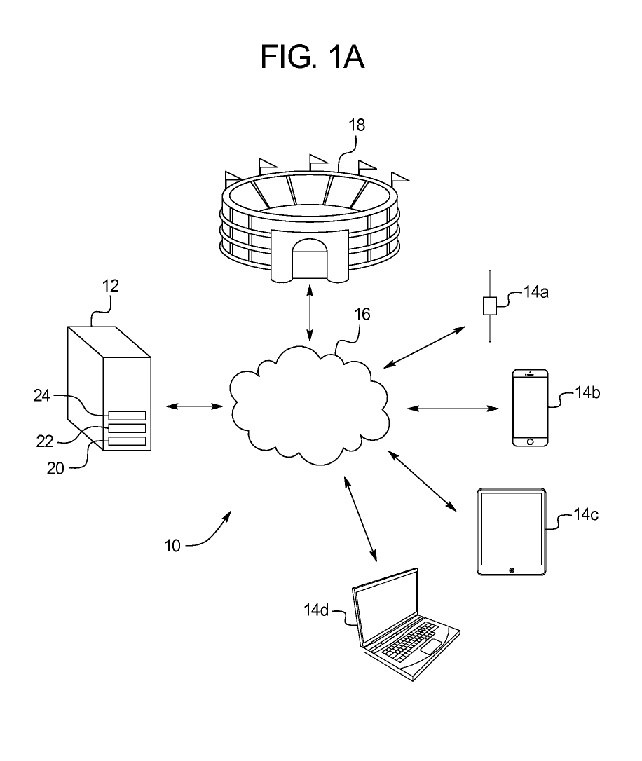

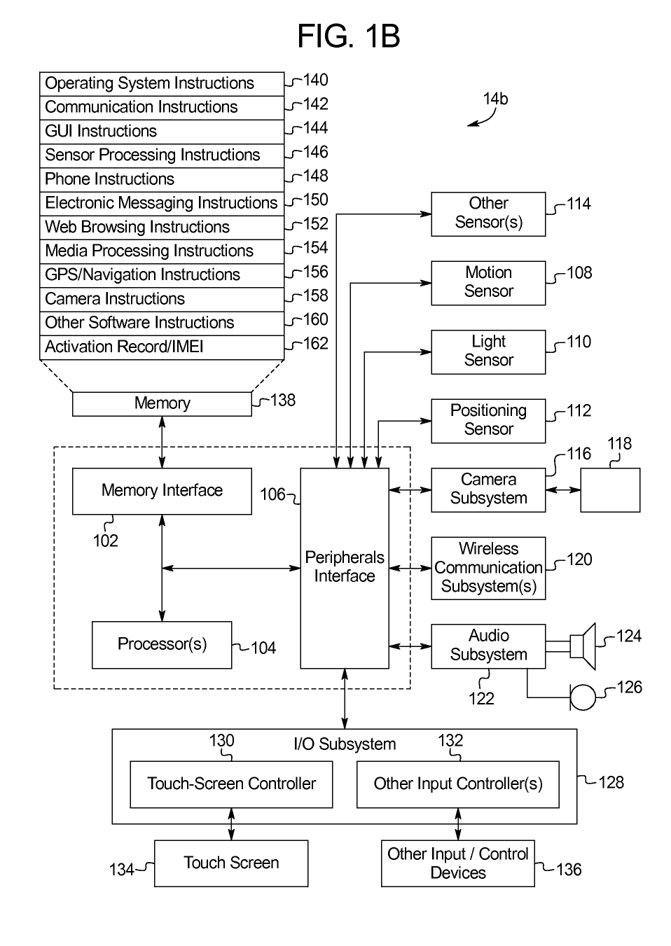

FIG. 1A is a schematic representation of a system 10 embodying the methods described herein. As shown in FIG. 1A, the system 10 includes a server 12 in communication with a number of distributed devices 14 through a communications network 16. As further shown, information related to a live event is communicated through the communications network from a venue 18. In the example shown in FIG. 1A, the venue 18 is an NFL stadium. Those skilled in the art will recognize that the venue 18 itself is not in direct communication with the communications network 16, but rather that the venue 18 is the location from which any of a number of communications devices may communicate through the communications network 16.

As will be understood by those skilled in the art, the server 12 shown in FIG. 1A includes a processor 20 and computer-readable memory 22 that stores computer instructions that are executable on the processor 20 directly (e.g., as compiled code) or indirectly (e.g., as a script interpreted by another application executing on the processor 20). The computer-readable memory 22 may include volatile and/or non-volatile memory to store computer instructions and data on which the computer instructions operate at runtime. The server 10, further includes a communications subsystem 24 enabling communications through the communications network 16.

The communications network 16 may be any communications network through which the elements of the system 10 may communicate, including, for example, a computer network (e.g., LAN, WAN, MAN, etc.), a telephone network (e.g., wireless network, etc.), the Internet, or other known communications network protocol.

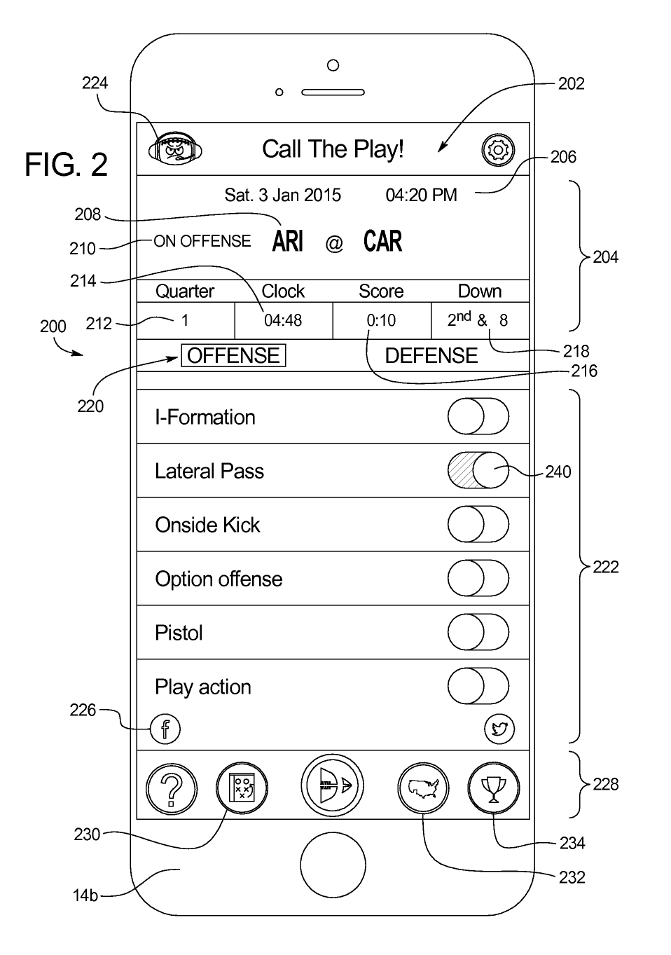

The distributed devices 14 may be any user device that capable of providing the user interface 200 described further herein with respect to FIGS. 2-9. As shown in FIG. 1A, examples of the distributed devices 14 include, a smartwatch 14a, a smartphone 14b, a tablet computer 14c, a laptop computer 14d, etc. FIG. 1B is a schematic representation of the elements of an example of a distributed device 14. In the example shown in FIG. 1B, the distributed device 14 is a smartphone 14b. The smartphone 14b shown in FIG. 1B is representative of the other distributed devices 14.

As shown in FIG. 1B, the smartphone 14b includes a memory interface 102, one or more data processors, image processors and/or central processors 104, and a peripherals interface 106. The memory interface 102, the one or more processors 104 and/or the peripherals interface 106 can be separate components or can be integrated in one or more integrated circuits. The various components in the smartphone 14b can be coupled by one or more communication buses or signal lines, as will be recognized by those skilled in the art.

Sensors, devices, and additional subsystems can be coupled to the peripherals interface 106 to facilitate various functionalities. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through one or more wireless communication subsystems 120, which can include radio frequency receivers and transmitters and/or optical (e.g., infrared) receivers and transmitters. The specific design and implementation of the communication subsystem 120 can depend on the communication network(s) over which the smartphone 14b is intended to operate. For example, the smartphone 14b can include communication subsystems 120 designed to operate over a GSM network, a GPRS network, an EDGE network, a Wi-Fi or WiMax network, and a Bluetooth™ network. In particular, the wireless communication subsystems 120 may include hosting protocols such that the smartphone 14b may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 can include a touch screen controller 130 and/or other input controller(s) 132. The touch-screen controller 130 can be coupled to a touch screen 134. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 can be coupled to memory 138. The memory 138 can include high-speed random access memory and/or non-volatile memory, such as one or more magnetic disk storage devices, one or more optical storage devices, and/or flash memory (e.g., NAND, NOR). The memory 138 can store operating system instructions 140, such as Darwin, RTXC, LINUX, UNIX, OS X, iOS, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 138 may also store communication instructions 142 to facilitate communicating with one or more additional devices, one or more computers and/or one or more servers. The memory 138 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 138 may also store other software instructions (not shown) controlling other processes and functions of the smartphone 14b as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 138.

Each of the above identified instructions and applications can correspond to a set of instructions for performing one or more functions described herein. These instructions need not be implemented as separate software programs, procedures, or modules. The memory 138 can include additional instructions or fewer instructions. Furthermore, various functions of the smartphone 14b may be implemented in hardware and/or in software, including in one or more signal processing and/or application specific integrated circuits.

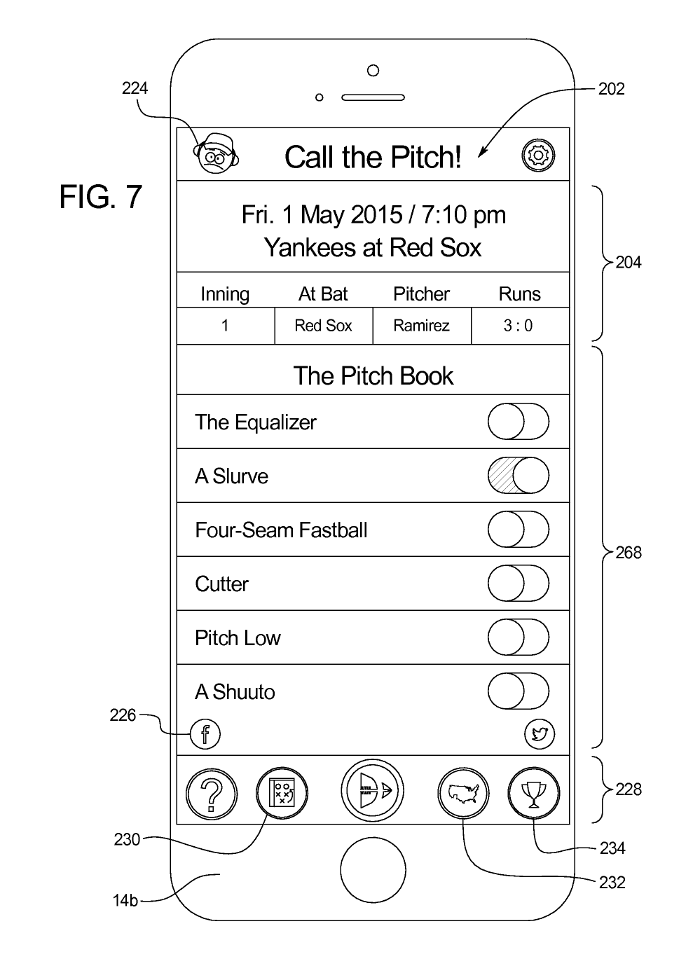

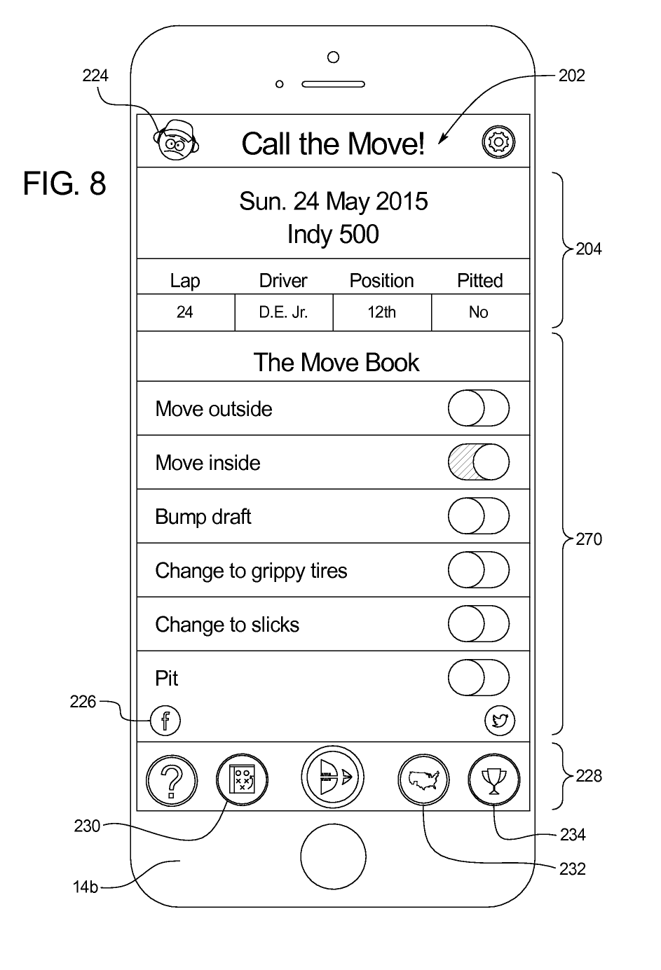

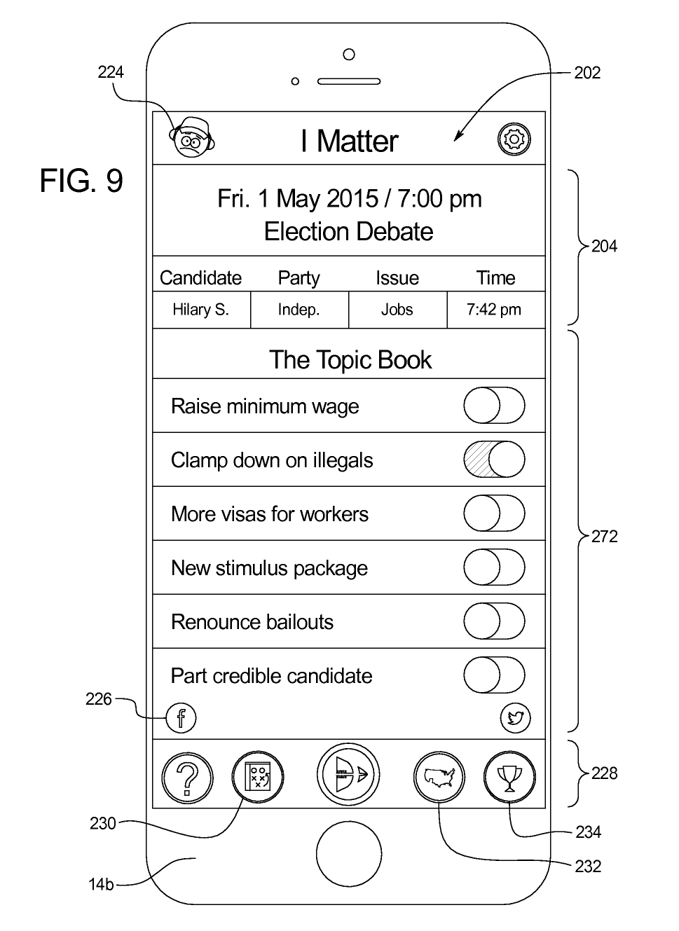

FIGS. 2-9 illustrate simulated screenshots of the operation of application programs implemented using the system 10 described with reference to FIGS. 1A and 1B. FIGS. 2-6 relate to a first application related to an NFL game, FIG. 7 relates to a second application related to an MLB game, FIG. 8 relates to a third application related to a car race, and FIG. 9 relates to a fourth application related to a political debate. These examples are illustrative of the various features and functions that may be implemented by the systems 10 presented herein. It is understood that these are not the only live events, or the only types of live events, to which the advantages provided by the subject matter disclosed herein may be directed.

Turning now to FIG. 2, a smartphone 14b embodies a user interface 200 that provides an opinion sharing mechanism 202. In this specific example, the opinion sharing mechanism is an NFL game related opinion sharing mechanism 202. The NFL game related opinion sharing mechanism 202 generally includes a live event information section 204 including data detailing the time and date 206, the teams playing 208, the team having possession of the ball 210, the quarter 212, the game clock 214, the score 216, and the down and distance 218. While generally believed to be the appropriate information to be shared for an NFL game related opinion sharing mechanism 202, the live event information section 204 may include more or less information as will be appreciated by those skilled in the art. For example, the live event information section 204 may include weather information (e.g., temperature, indication of wind, rain, snow, etc.) or other relevant conditions.

In the example shown in FIG. 2, a side of the ball selection section 220 is located below the live event information section 204. As shown, the side of the ball selection section 220 enables a user to choose whether to offer an opinion regarding the next play from the perspective of the offense or the defense. In the example shown, the side of the ball selection section 220 has been used to select the offensive side of the ball. Accordingly, the play selection section 222 displays offenses plays from which the user may make a selection.

In the example shown in FIG. 2, the offensive plays provided in the play selection section 222 include: I-formation, lateral pass, onside kick, option offense, pistol, play action. It is recognized that this is a non-exhaustive listing of offensive plays, but that the details provided are appropriate to teach those skilled in the art how to implement a play selection section 222.

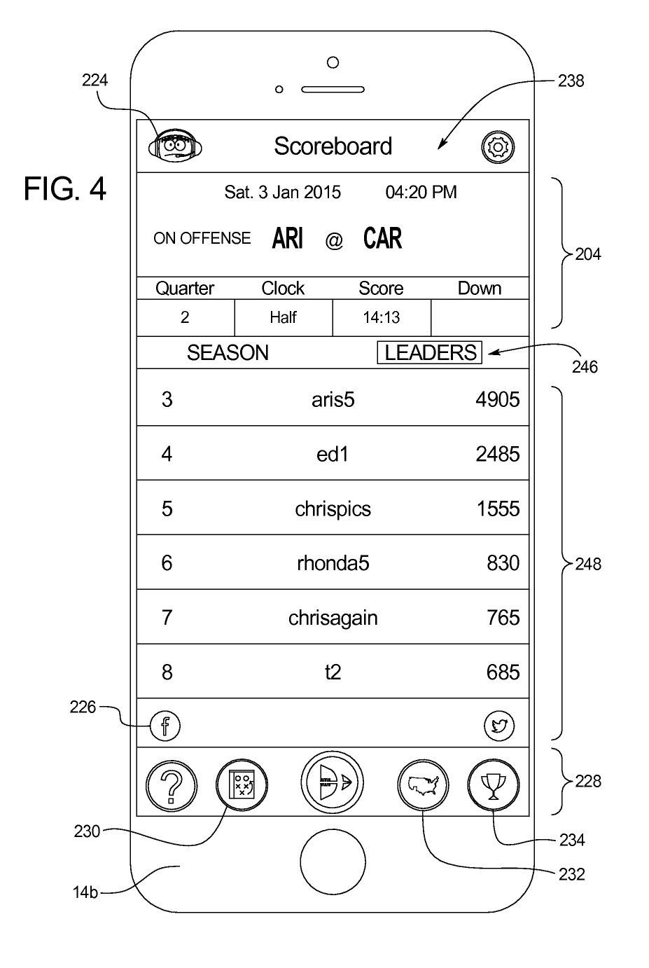

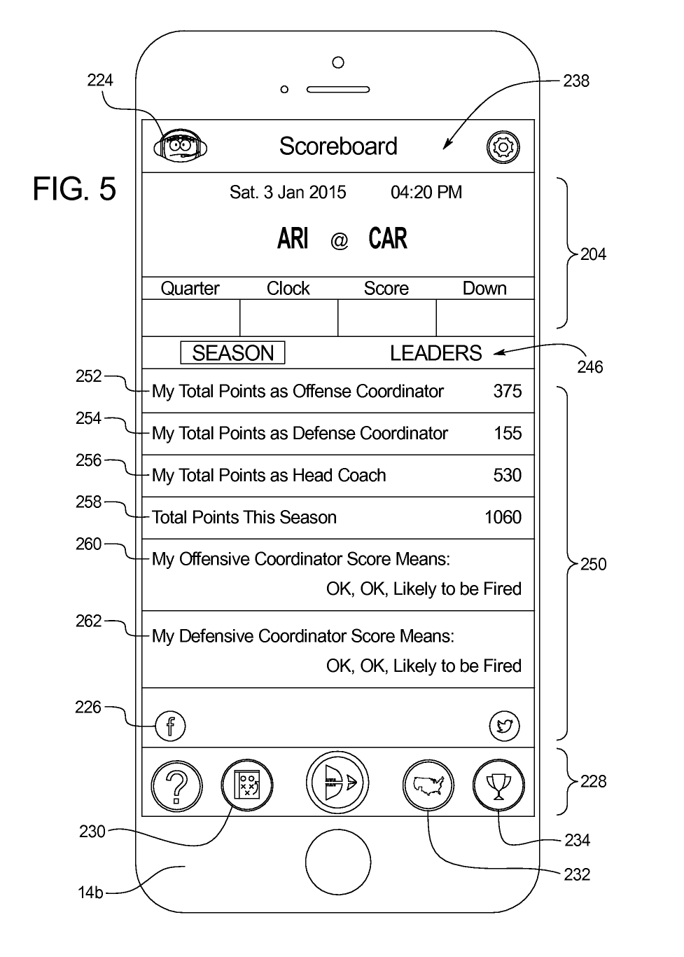

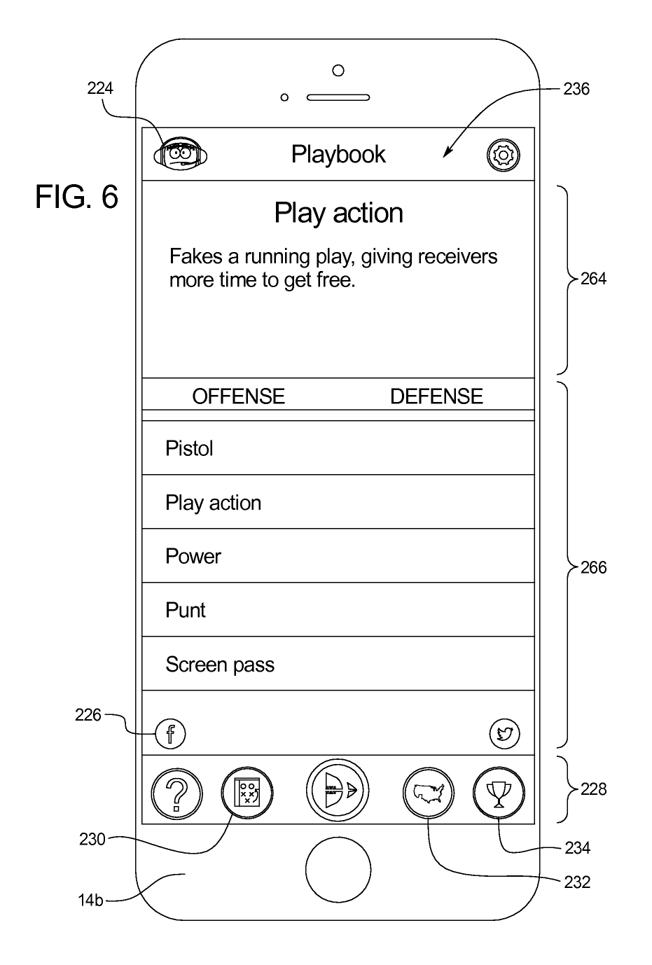

Additional options are provided at the top and the bottom of the of the NFL game related opinion sharing mechanism 202. For example, in the upper left corner of the example shown in FIG. 2, a mood icon 224 is used to display the mood of the user. The mood icon 224 can be selected from amongst a group of icons representing varied moods including, for example, confident, excited, happy, sad, confused, etc. As shown below the play selection section 222, there are additional social media icons 226 through which a user can share information to other social media platforms. As further shown, additional user interface modules can be selected using the user interface module selection icons 228. For example, the playbook icon 230 takes the user to a playbook module 236 (FIG. 6), the map icon 232 takes a user to a map showing the locations of users of the application, and the trophy icon 234 takes a user to a scoreboard module 238 (FIGS. 4 and 5).

In use, a user may identify the selected game for which the user is to offer an opinion as to which play will be run next by reviewing the live event information section 204. If the game information matches the game for which the user wishes to offer an opinion, the user may then select the side of the ball for which to offer an opinion using the side of the ball selection section 220. Then, once the side of the ball is selected, the play selection section 222 is populated with plays from the corresponding side of the ball. The user may then make a selection of a play using a selection mechanism 240, such as the slider button 240 shown in FIG. 2. It is understood that there are numerous selection mechanisms 240 that may be used and, further, that the selection mechanism 240 may be a multi-level selection such as Play Action/Pass/Deep/Right. Of course, there are numerous forms in which the play selection section 222 may be embodied.

Once the user selects a play, the smartphone 14b communicates the selection back to the server 12, where the information is compared to the information received from the other distributed devices 14. Based on the comparison by the server 12, a determination is made as to the points assigned to each user and related data is communicated back to the distributed devices 14. Such information is communicated to the users in a scoring display 242 that temporarily replaces the NFL game related opinion sharing mechanism 202.

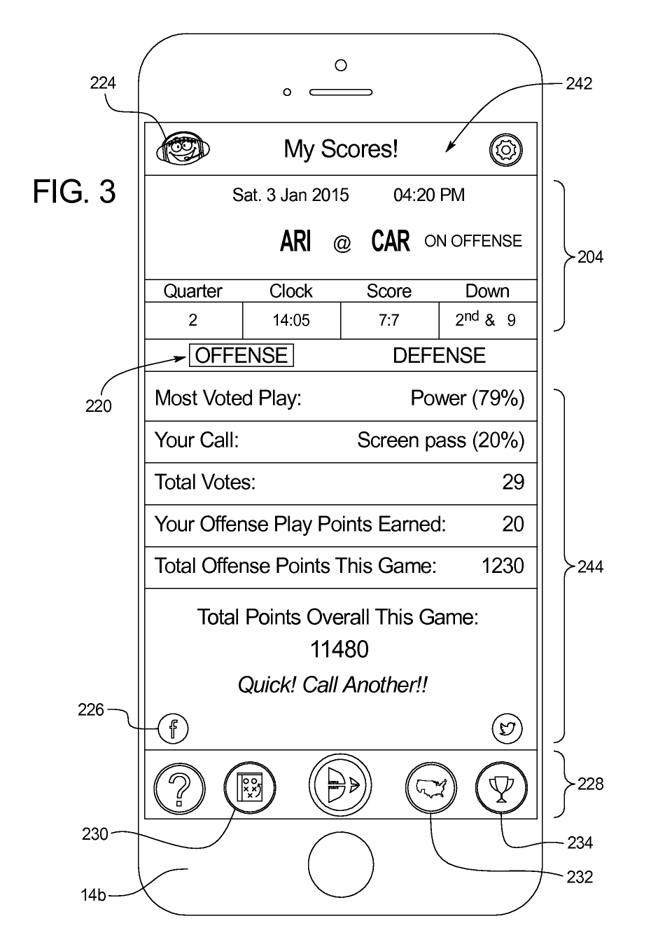

Turning to FIG. 3, after a user has made a selection. NFL game related opinion sharing mechanism 202 is temporarily replaced by the scoring display 242. The scoring display 242 includes much of the same information as the NFL game related prediction entry mechanism 202, including, amongst other things, the same live event information section 204 and user interface module selection icons 228. The main distinction is the my scores section 244 shown in FIG. 3. For each side of the ball, the my scores section 242 includes: the play most commonly selected (e.g., Power) and the percentage of users selecting that play; the user's call (e.g., Screen pass) and the percentage of users selecting that play; the total votes (e.g., 29); the points earned on that side of the ball (e.g., 20); the total points earned this game on that side of the ball (e.g., 1230); and the total overall points earned for this game (e.g., 11480). The scoring display 242 may return to the NFL game related opinion sharing mechanism 202 after a short time has passed or in response to a user touching the screen of the user interface 200 or other similar user action.

When the user wants to access scores, the user can use the trophy icon 234 to access the scoreboard module 238 shown in FIGS. 4 and 5. As shown in FIG. 4, the scoreboard module 238 includes a season or leaders selection tool 246 that enables the user to view different aspects of the scoreboard module 238. In FIG. 4, the leaders board 248 is selected and displayed. As shown, the leaders board 248 shows the users' names, rank, and total points. It is understood that an alternate embodiment of the leaders board 248 may show more or less information.

As shown in FIG. 5, when the season board 250 is selected, the user is shown: the user's total points as an offensive coordinator 252 (e.g., 375); the user's total points as a defensive coordinator 254 (e.g., 155); the user's total points as a head coach 256 (e.g., 530); the user's total points this season 258 (e.g., 1060); the rating of the offensive coordinator score 260 (e.g., OK, OK, Likely to be Fired); and the rating of the defensive coordinator score 262 (e.g., OK, OK, Likely to be Fired). The statistics displayed may vary, as will be recognized by those skilled in the art based on the disclosures provided herein, whether within the field of NFL games or to more appropriately match the subject of the application.

Turning now to FIG. 6, the playbook module 236 is shown. When a user selects the playbook icon 230 from amongst the user interface module selection icons 228, the user is presented the playbook module 236. As shown, the playbook module 236 includes a play definition section 264 and a play selection section 266. Through the play selection section 266, a user may view the offensive and defensive plays that may be selected in the NFL game related opinion sharing mechanism 202, make a selection, and read the definition of the play in the play definition section 264. This playbook module 236 is useful to users that would like to learn more about the elements of the live event for which they are offering their opinions.

Turning now to FIGS. 7-9, variations of the opinion sharing mechanism 202 are shown. While FIG. 2 illustrated an NFL game related opinion sharing mechanism 202, FIG. 7 shows an MLB game related opinion sharing mechanism 202, FIG. 8 shows a racing related opinion sharing mechanism 202, and FIG. 9 shows a political event related opinion sharing mechanism 202. These non-exhaustive alternative examples of opinion sharing mechanisms 202 are provided to illustrate the variety of live events to which the subject matter of the present disclosure may be applied. Those skilled in the art will recognize additional examples based on the descriptions provided herein.

As shown in FIG. 7, the MLB game related opinion sharing mechanism 202 includes a live event information section 204 that includes information about the MLB game to which the opinion sharing mechanism 202 is directed. In this example, it is the May 1, 2015, Yankees/Red Sox game. The MLB game related opinion sharing mechanism 202 further includes a pitch selection section 268 displaying pitches from which the user may make a selection.

In the example shown in FIG. 7, the pitches provided in the pitch selection section 268 include: The Equalizer, a Slurve, Four-Seam Fastball, Cutter, Pitch Low, A Shuuto. It is recognized that this is a non-exhaustive listing of pitches, but that the details provided are appropriate to teach those skilled in the art how to implement a pitch selection section 268.

As shown in FIG. 8, the racing related opinion sharing mechanism 202 includes a live event information section 204 that includes information about the race to which the opinion sharing mechanism 202 is directed. In this example, it is the May 24, 2015, Indianapolis 500. The racing related opinion sharing mechanism 202 further includes a move selection section 270 displaying moves from which the user may make a selection.

In the example shown in FIG. 8, the moves provided in the move selection section 270 include: Move outside, Move inside, Bump draft, Change to grippy tires, Change to slicks, Pit. It is recognized that this is a non-exhaustive listing of racing moves, but that the details provided are appropriate to teach those skilled in the art how to implement a move selection section 270.

As shown in FIG. 9, the political event related opinion sharing mechanism 202 includes a live event information section 204 that includes information about the political event to which the opinion sharing mechanism 202 is directed. In this example, it is a May 1, 2015, election debate. The political event related opinion sharing mechanism 202 further includes a topic selection section 272 displaying topics from which the user may make a selection.

In the example shown in FIG. 9, the topics provided in the topic selection section 272 include: Raise minimum wage, Clamp down on illegals, More visas for workers, New stimulus package, Renounce bailouts, Part credible candidate. It is recognized that this is a non-exhaustive listing of topics, but that the details provided are appropriate to teach those skilled in the art how to implement a topic selection section 272.

In the example shown in FIG. 9, it can be understood that the topic selection section 272 may be populated based on suggestions made by users. Once a user makes a suggestion, it may then be populated into the topic selection section 272 for other users to select. The information is maintained in the server 12 so it can be communicated to each of the distributed devices 14.

It should be noted that various changes and modifications to the presently preferred embodiments described herein will be apparent to those skilled in the art. Such changes and modifications may be made without departing from the spirit and scope of the present invention and without diminishing its attendant advantages.

1. A system for sharing opinions related to live events, the system comprising:
a processor; and
a memory including instructions that when executed by the processor cause it to:
provide a first graphical user interface embodying an opinion sharing mechanism including:
a live event information section including real-time information related to an associated live event; and
an action selection section including user controls through which a first user makes a user selection to share a first user opinion related to the associated live event, wherein the first user opinion shared is a selection of an identifiable action that may transpire within the live event;
receive the first user selection;
compare the received user selection against a plurality of additional user selections received from a corresponding number of additional users that provide the additional user selections through additional opinion sharing mechanisms including:
a live event information section including real-time information related to an associated live event; and
an action selection section including user controls through which the additional users make their user selections to share the additional user opinions related to the associated live event, wherein the additional user opinions shared are a selection of identifiable actions that may transpire within the live event;
in response to the comparison of the first user selection against the additional user selections, display, through the first graphical user interface, a scoring display communicating:
the identifiable action most commonly selected;
the percentage of users selecting the most commonly selected identifiable action;
the identifiable action selected by the first user; and
the percentage of users selecting the identifiable action selected by the first user.

2. The system of claim 1 wherein the live event is an NFL game.

3. The system of claim 2 wherein the selection of an identifiable action that may transpire within the live event is the selection of an offensive play or a defensive play.

4. The system of claim 3 wherein the real-time information related to the associated live event includes situational data for the NFL game including team names, a score, a quarter, a team having possession of the ball, and a down.

5. The system of claim 4 wherein the action selection section includes a selection to access offensive plays or defensive plays.

6. The system of claim 3 wherein the first graphical user interface further includes a playbook module including a play definition section and a play selection section, wherein user selection of a play displayed in the play selection section causes a description of the play to appear in the definition section.

7. The system of claim 1 wherein the live event is an MLB game.

8. The system of claim 7 wherein the selection of an identifiable action that may transpire within the live event is the selection of a pitch.

9. The system of claim 1 wherein the live event is an automobile race.

10. The system of claim 9 wherein the selection of an identifiable action that may transpire within the live event is the selection of a driving move.

11. The system of claim 1 wherein the live event is a political debate.

12. The system of claim 11 wherein the selection of an identifiable action that may transpire within the live event is the selection of a political topic.

13. The system of claim 1 further wherein in response to the comparison of the first user selection against the additional user selections, the processor displays, through the first graphical user interface, a scoring display communicating points assigned to the first user based on the degree of agreement between the first user selection and the additional user selections.
